(19) United States
(12) Patent Application Publication
(10) Pub. No.: US 2008/0252426 A1
(43) Pub. Date: Oct. 16, 2008

(54) Intelligent Rfid System For Low Powered Reader-Tag Communication and Method Thereof

(75) Inventors: Hong Bae Lee, Seoul (KR); Key Hyun Kim, Geonggi-do (KR); Jae Cheol Shin, Gyeonggi-do (KR); Jung Suk Lee, Seoul (KR); Jun Seok Park, Gyeonggi-do (KR); Ha Ryoung Oh, Gyeonggi-do (KR); Moon Que Lee, Seoul (KR); Byung Jun Jang, Daejeon-si (KR)

Correspondence Address: HOFFMANN & BARON, LLP, 6900 JERICHO TURNPIKE, SYOSSET, NY, 11791, US

(73) Assignee: C & S Microwave Co., Ltd., Seongnam (KR)

(21) Appl. No.: 11/815,476

(22) PCT Filed: Jan. 6, 2006
(86) PCT No.: PCT/KR06/00054

§ 371 Date: Jan. 30, 2008

(30) Foreign Application Priority Data
Feb. 7, 2005 (KR) 10-2005-0011236

(51) Int. Cl. H04B 7/24

(52) U.S. Cl. 340/10.3

(57) ABSTRACT

The present invention relates, in general, to a Radio Frequency Identification (RFID) system for reading or recording RFID tag information using radio frequencies and, more particularly, to an intelligent RFID system for low-powered reader-tag communication, which includes an RF shower system (370) that radiates a high power electromagnetic wave in a high frequency band to activate the passive tags having no batteries and that has predetermined communication means for reading information from a plurality of passive tags existing in a radiation zone having a predetermined size, storing the read tag information, and providing the stored tag information when a request is received from an RFID reader (310).

### TECHNICAL FIELD

The present invention relates, in general, to a Radio Frequency IDentification (RFID) system for reading or recording information about an RFID tag using radio frequencies and, more particularly, to an intelligent RFID system for low-powered reader-tag communication, which is constructed to include an RFID shower system that radiates high power electromagnetic waves in a high frequency band so as to activate a plurality of passive tags having no batteries, and that has a communication means to read information from the plurality of passive tags existing in a radiation zone having a predetermined size, store the read tag information, and provide stored tag information when a request is received from an RFID reader.

### BACKGROUND ART

Generally, Radio Frequency Identification (RFID) is a technology for reading or recording information from or on a tag, having unique identification information, in a non-contact method using radio frequencies, thus identifying, tracing or managing objects, animals or persons to which tags are attached. An RFID system includes a plurality of tags or transponders, having unique identification information and attached to objects or animals, and an RFID reader or interrogator for reading information stored on the tags or writing information on the tags.

FIG. 1 is a diagram showing the basic construction of an RFID system. As shown in FIG. 1, an RFID tag 5 includes an antenna and an Integrated Circuit (IC) chip, and the IC chip has an RF circuit for processing high frequency signals, a control logic, memory, etc. An RFID reader 1 transmits a radio frequency (RF) in a specific frequency band to the tag 5, and receives a high frequency signal reflected from the tag 5. The reader 1 includes an antenna and an RF transmission/reception unit for transmitting or receiving a radio frequency, and a signal processing unit for processing signals.

Meanwhile, the RFID reader 1 can be connected to information technology equipment, such as a computer, and the information technology equipment analyzes and stores information read by the RFID reader, using predetermined middleware or application programs.

FIG. 2 is a diagram showing the basic operation of a conventional RFID system. As shown in FIG. 2, in the conventional RFID system, the tag 5 is a passive tag having no battery. Therefore, in order to realize communication between the reader 1 and the tag 5, the passive tag 5 must be first activated. For this operation, the reader 1 transmits power together with a predetermined interrogation signal. Then, the passive tag 5 is activated using the power transmitted from the reader 1, and transmits information thereof to the reader 1. In this way, the conventional RFID system transmits radio power together with communication between the reader 1 and the tag 5.

Generally, there are two methods for the RFID reader to transmit power in a wireless manner. One is a method using a coil composed of multiple windings and formed on both a reader and a tag, and the other is a method using electromagnetic waves in a high frequency band between a reader and a tag. However, a magnetic field coupling method using a coil composed of a single winding can only be used for limited purposes, such as logistics management, entrance management, and traffic cards, because the method can identify tags only within a very short range. In contrast, recently, a high frequency method capable of increasing the identification range to 10 m or more has been mainly used. Such a high frequency method can further increase, in theory, the communication distance between a tag and a reader if the power of a high frequency wave transmitted by the reader is increased. However, as the transmission power of the reader increases, frequency interference may occur between adjacent readers or radio communication devices using the same or similar frequencies. Further, in order to radiate a high frequency wave at high power, there are problems in that the volume of the reader, the consumption of battery power and the cost of the product increase.

Such problems may become a great obstacle to the mounting of an RFID reader in, for example, a personal mobile communication terminal in the future. Further, in the conventional RFID system, a passive tag only functions to reflect an identification code and information. Therefore, such a passive tag is activated only when it exchanges information with the RFID reader. However, in a recent RFID system, an active tag, in which a processor and memory are provided to enable the reading/writing of data and which is continuously activated to sense environmental information, has been required. However, an active tag having a battery therein is disadvantageous in that the price thereof increases, the miniaturization thereof is difficult, and the usage duration is limited depending on the lifespan of a battery. Therefore, a passive tag that can be continuously activated without including a battery has been required.

Meanwhile, in the generation of a Ubiquitous Sensor Network (USN), it is forecasted that subminiature tags will also be attached to vehicles, animals or persons, as well as to objects, such as the walls or floors of buildings and telegraph poles or paving blocks on streets, and readers capable of reading tag information will be installed at a plurality of places, or a user will carry a reader, collect surrounding environmental information in real time and transmit the collected information through a network. Therefore, the tags used in USN have been required to have additional sensing and memory functions, in addition to the function of transmitting only identification information, as in the prior art, and to function as a ubiquitous sensor (u-sensor) for sensing information about the surrounding environment (temperature, humidity, pollution information, crevice information, etc.) by themselves and actively transmitting the environmental information to the network. Therefore, in advance of constructing such a Ubiquitous Sensor Network (USN), the development of a tag having a low cost, high functionality, and a very small size is required. As described above, a tag suitable for a USN must have a low price and a small size in such a way that it can be installed anywhere, and must have a sensing function and store or process a great amount of information. Therefore, in order for an inexpensive passive tag to sufficiently perform such a function, power must be continuously supplied by an external part. However, in the conventional RFID system, since a passive tag is supplied with energy required for operation by a reader, the tag cannot be activated if the reader does not exist or is not operating. Therefore, the function of the passive tag to continuously sense environmental information cannot be expected. Further, in order for the conventional passive tag and reader to guarantee a sufficient identification range and achieve high functionality, the power of a frequency transmitted by the reader must be greatly increased. However, there is a problem in that, as the power of the RFID reader increases, the frequency interference between adjacent readers may increase. Furthermore, in order for the passive tag to perform a continuous sensing function, the reader must be located close to the tag, so that the mobility of the reader is greatly restricted.

In order to solve this problem, in an RFID system and method for low-powered reader-tag communication, previously filed by the present inventor (Korean Patent Appln. No. 10-2004-73991), an RF shower system for radiating a high frequency wave in a predetermined frequency band to continuously supply power to a passive tag was proposed.

That is, as shown in FIG. 3, a conventional RFID system for low-powered reader-tag communication includes an RFID reader 10, a passive tag 50 and an RF shower system 70. Further, the RFID reader 10 communicates with the passive tag 50 in a wireless manner using an RF signal f1 in a predetermined frequency band. The RF shower system 70 radiates a high frequency wave f2 in a predetermined frequency band, and supplies power to a plurality of passive tags 50 existing in a radiation zone having a predetermined size in a wireless manner. Therefore, each passive tag 50 is activated using the high frequency wave f2 radiated by the RF shower system 70, and exchanges an interrogation signal and a response signal using the RF signal f1 transmitted by the reader 10. Therefore, the transmission of power does not occur between the reader 10 and the passive tag 50. Accordingly, an RFID reader 10 that does not require power transmission can enable a major decrease in the power of the RF signal f1. Such a major decrease in the power of the RFID reader 10 is critical to solve the problem of frequency interference between readers, which may be expected when the RFID readers are mounted in personal mobile communication terminals. However, in the above previously filed patent, that is, the RFID system and method for low-powered reader-tag communication (Korean Patent Appln. No. 10-2004-73991), the RF shower system 70 only supplies power to the tag 50, so that there is a disadvantage in that the number of tags 50, the information of which is identified by the reader 10, is inevitably limited.

Further, in such a conventional RFID system, since both the RFID reader 10 and the passive tag 50 use the RF signal f1 having very low power, communication is possible only when the reader 10 and the tag 50 are close to each other. That is, in order to realize complete communication between the RFID reader 10 and the tag 50, an Interrogation zone (In) of the reader 10 and a Response zone (Re) of the tag 50 must overlap each other. However, the size of the interrogation zone In of the reader 10 is proportional to the power of the RF signal f1 radiated by the reader, and the response zone Re of the tag 50 is also proportional to the power of the RF signal f1. Accordingly, as the power of the RF signal f1, radiated by the RFID reader 10, is decreased, the range of identification of the reader 10 is narrowed. Therefore, there may occur a problem in use in that, in order to read information from a plurality of passive tags, spaced apart from each other, using the RFID reader, a user must always carry the reader, and must personally bring the reader near each of the plurality of tags while searching for the tags.

### DISCLOSURE

### Technical Problem

Accordingly, the present invention has been made keeping in mind the above problems occurring in the prior art, and an object of the present invention is to provide an RFID system for low-powered reader-tag communication, which can easily obtain information about tags existing outside of the interrogation zone of an RFID reader, that is, outside of the range of identification. Another object of the present invention is to provide an RFID system for low-powered reader-tag communication, which includes an RF shower system for continuously or intermittently supplying high power to a plurality of passive tags having no batteries in a wireless manner, reading information from the plurality of passive tags while communicating with the passive tags, and storing the read information.

A further object of the present invention is to provide an RFID system for low-powered reader-tag communication, which includes an RF shower system capable of providing information, read from a plurality of tags existing in a radiation zone, at the request of an RFID reader. Yet another object of the present invention is to provide an RFID system for low-powered reader-tag communication, which includes an RF shower system capable of controlling RF signals transmitted by a plurality of RFID readers and arbitrating collisions between RFID readers using the same frequency band. Still another object of the present invention is to provide an intelligent RFID system for low-powered reader-tag communication, in which a plurality of passive tags is installed independent of a reader to perform high functions and multiple functions, and which provides an RF shower system capable of supplying operating power using a high frequency wave in a predetermined frequency band, or functioning as a reader, such as by acquiring and storing information about tags, and functioning as a tag, such as by transmitting the tag information to the reader at the request of the reader, thus realizing the low cost and miniaturization of tags, and solving the problem of frequency interference between readers.

Still another object of the present invention is to provide an intelligent RFID system for low-powered reader-tag communication, which includes an RFID mobile communication terminal, having therein an RFID reader, to perform radio communication with an RF shower system as well as a passive tag activated by a high frequency wave radiated by the RF shower system. Further, still another object of the present invention is to provide an intelligent RFID system for low-powered reader-tag communication, which maintains existing communication methods and protocols between tags and a reader without change, for the communication between an RF shower system and the reader, so that the reader can be used after only the power thereof is decreased, without requiring a separate RF unit and protocol (wireless Local Area Network [LAN], Bluetooth, zigbee, etc.), thus enabling the reader to function as an independent reader in a region in which no RF shower system exists, without imposing additional costs for the reader.

### Technical Solution

In order to accomplish the above objects, the present invention provides an intelligent Radio Frequency Identification (RFID) system for low-powered reader-tag communication, the RFID system including an RFID reader and one or more passive tags, comprising an RF shower system for radiating electromagnetic waves in a predetermined frequency band to activate the passive tags, the RF shower system including predetermined communication means to read information from a plurality of passive tags existing in a radiation zone having a predetermined size and to provide stored tag information when a request is received from the RFID reader, wherein the RF shower system functions as an RFID reader with respect to the passive tags, and functions as an active tag. Further, the present invention provides an intelligent Radio Frequency Identification (RFID) method for low-powered reader-tag communication, the RFID method being performed using an intelligent RFID system for low-powered reader-tag communication, the RFID system including an RFID reader, one or more passive tags, and an RF shower system radiating electromagnetic waves in a high frequency band to activate the passive tags, and having communication means capable of communicating with both the RFID reader and the passive tags, the RFID method comprising an activation step of the RF shower system radiating a high frequency wave in a predetermined frequency band, transmitting power to one or more passive tags existing in a radiation zone thereof, and then activating the passive tags; an RF shower system interrogation step of the RF shower system transmitting an interrogation signal to the plurality of activated passive tags existing in the radiation zone, using the high frequency wave in a predetermined frequency band; a passive tag response step of the plurality of passive tags, existing in the radiation zone of the RF shower system, performing backscattered modulation on the high frequency wave received from the RF shower system, thus transmitting a response signal; a tag information storage step of the RF shower system storing tag information, read from the plurality of passive tags, in memory; an RFID reader interrogation step of the RFID reader transmitting an interrogation signal to the RF shower system, using an RF signal in a predetermined frequency band; an RF shower system response step of the RF shower system providing tag information, stored in the memory, using the RF signal in a predetermined frequency band, in response to the interrogation signal from the RFID reader; an RFID reader recording step of the RFID reader transmitting a predetermined recording signal to the RF shower system using the RF signal in a predetermined frequency band; and an RF shower system recording step of the RF shower system receiving the recording signal from the reader, and transmitting recording information to the tags using a predetermined high frequency signal.

### ADVANTAGEOUS EFFECTS

An intelligent RFID system for low-powered reader-tag communication according to the present invention is advantageous in that an RF shower system, functioning to supply operating power to a plurality of passive tags using electromagnetic waves, collect information about tags and transmit the tag information to the reader, is separately installed, thus realizing the low cost of tags, and sufficiently solving the problem of frequency interference between readers. Further, the present invention is advantageous in that, since it does not require the transmission of power between a reader and tags, the miniaturization and low cost of the RFID system are possible due to the implementation of a low-powered reader, and since the reader is installed in a mobile communication terminal, such as an existing mobile phone or Personal Digital Assistant (PDA), a combination reader and mobile communication terminal can be provided. Further, the RFID reader of the present invention is advantageous in that it reads information about a plurality of passive tags using an RF shower system, thus easily obtaining information about tags existing outside of the interrogation zone of the RFID reader, that is, the range of identification thereof.

### DESCRIPTION OF DRAWINGS

FIG. 1 is a diagram showing the basic construction of a conventional RFID system;

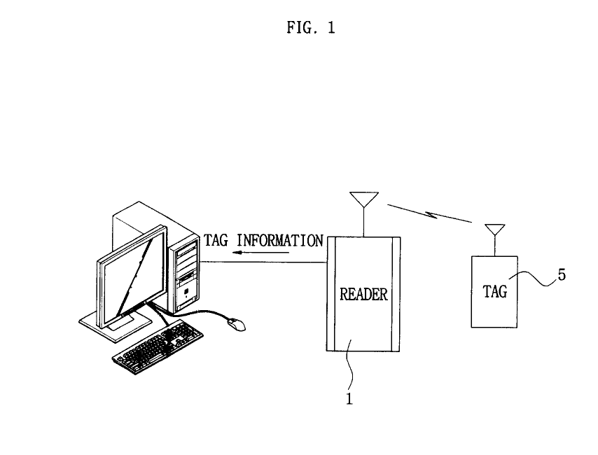

FIG. 2 is a diagram showing the operation of the conventional RFID system;

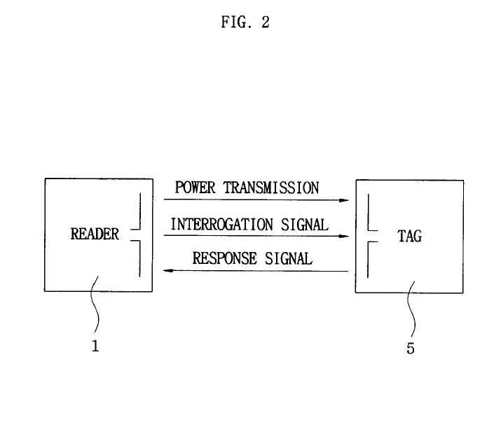

FIG. 3 is a diagram showing the basic construction of a conventional RFID system for low-powered reader-tag communication;

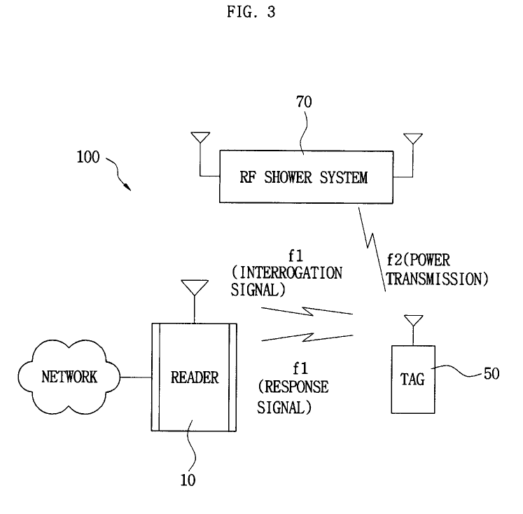

FIG. 4 is a diagram showing the basic construction of an intelligent RFID system for low-powered reader-tag communication according to the present invention;

FIG. 5 is a diagram showing the construction of an embodiment of an intelligent RFID system according to the present invention;

FIG. 6 is a block diagram showing the construction of the reader, the passive tag and the RF shower system of the intelligent RFID system according to the present invention;

FIG. 7 is a block diagram showing the construction of another embodiment of the RF shower system according to the present invention; and

FIG. 8 is a diagram showing the construction of another embodiment of an intelligent RFID system according to the present invention.

### BEST MODEL

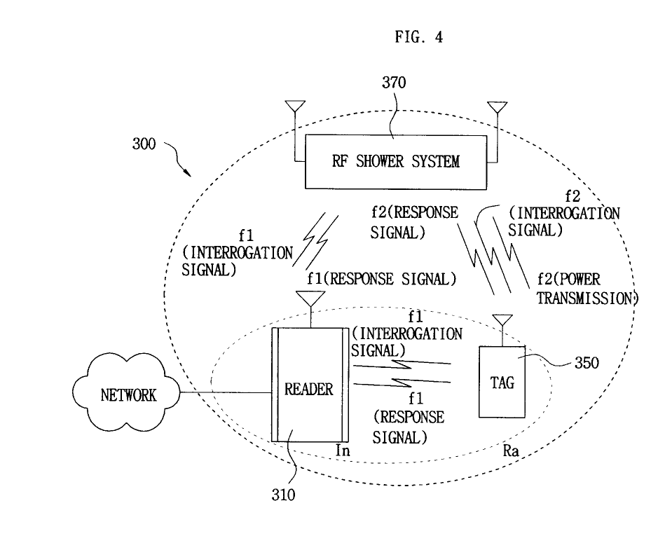

Hereinafter, embodiments of an intelligent Radio Frequency Identification (RFID) system for low-powered reader-tag communication according to the present invention will be described with reference to the attached drawings. FIG. 4 is a diagram showing the basic construction of an intelligent RFID system for low-powered reader-tag communication according to the present invention. The intelligent RFID system 300 of the present invention includes an RFID reader 310, a passive tag 350 and an RF shower system 370. As shown in FIG. 4, radio communication is performed between the RFID reader 310 and the passive tag 350 using an RF signal f1 in a predetermined frequency band. Further, radio communication is also performed between the RFID reader 310 and the RF shower system 370, using the RF signal f1 in a predetermined frequency band. Further, between the RF shower system 370 and the passive tag 350, not only the transmission of power but also radio communication for information exchange is performed using a high frequency wave f2 in a predetermined frequency band.

In this case, the RF signal f1 and the high frequency wave f2 may be identical to each other, or an arbitrary frequency f2 different from f1 may be selected and used. As described above, the RFID system 300 of the present invention is characterized in that radio communication between the RF shower system and the passive tag and between the RF shower system and the RFID reader, as well as communication between the RFID reader and the passive tag, is performed.

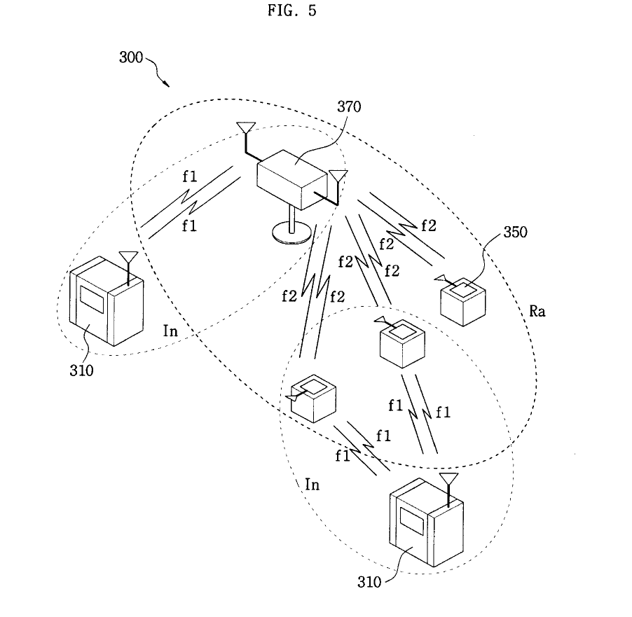

FIG. 5 is diagram showing the schematic construction of the intelligent RFID system for low-powered reader-tag communication according to the present invention. As shown in FIG. 5, according to the RFID system 300 of the present invention, the RFID reader 310 can communicate with the passive tag 350 in a typical method, thus reading information about tags. In this case, since the passive tag 350 does not include a battery therein, it is activated using a radio frequency wave radiated by the RF shower system 370. That is, the RF shower system 370 radiates the high frequency wave f2 in a predetermined frequency band so as to supply power to a plurality of passive tags 350. At this time, the RF shower system 370 forms a radiation zone Ra having a predetermined size depending on the power of the high frequency wave f2. All of the passive tags 350 existing in the radiation zone Ra are activated. Preferably, each activated passive tag 350 collects and stores surrounding environmental information using a sensor 360 provided in the passive tag 350. The information stored in this way is provided to the RFID reader 310 when a request is received from the RFID reader 310. That is, the RFID reader 310 transmits an interrogation signal to the passive tag 350 using the RF signal f1 in a predetermined frequency band. At this time, the RFID reader 310 forms an interrogation zone In having a predetermined size depending on the power of the RF signal f1. Therefore, all of the passive tags 350 existing in the interrogation zone In of the RFID reader 310 receive the RF signal f1, reflect the RF signal f1, and then transmit a response signal that includes unique identification information. In this case, the tag 350 also forms a response zone Re having a predetermined size depending on the power of the reflected RF signal f1. Further, when the response zone Re of the tag 350 and the interrogation zone In of the RFID reader 310 overlap each other, complete communication is performed. Therefore, information about a passive tag 350 that does not exist in the interrogation zone In of the RFID reader 310 cannot be read. However, in the communication between the RFID reader 310 and the passive tag 350, the power of the RF signal f1, transmitted by the RFID reader 310, is low, so that the sizes of the interrogation zone In of the RFID reader 310 and the response zone Re of the tag 350 are very small. Therefore, since the communication between the RFID reader 310 and the tag 350 is possible only when the distance between the reader and the tag is short, information about tags, which can be collected by the RFID reader 310, is greatly limited.

Next, the RF shower system 370 can read information from the passive tag 350 while communicating with the passive tag using the same method as a conventional reader-tag communication method. That is, the RF shower system 370 radiates the high frequency wave f2 at high power and forms a radiation zone Ra having a predetermined size. The radiation zone Ra of the RF shower system 370 is much larger than the interrogation zone In formed by the RFID reader 310. Further, the plurality of passive tags 350 existing in the radiation zone Ra performs communication using the high frequency wave f2 while being supplied with power through the high frequency wave f2 radiated by the RF shower system 370, thus collecting information from the plurality of passive tags 350. That is, the radiation zone Ra of the RF shower system 370 is the interrogation zone In of the RF shower system 370. Therefore, the RF shower system 370 can collect information from all of the passive tags 350 existing in the wide radiation zone Ra. As described above, in the intelligent RFID system 300 of the present invention, the RF shower system 370 can read information from the plurality of passive tags 350, regardless of the existence or non-existence of the RFID reader 310.

Further, the RF shower system 370 stores therein information, periodically collected from the plurality of passive tags 350 as necessity requires, and transmits the stored information to the RFID reader at the request of the RFID reader. That is, the RFID reader 310 reads information about tags, stored in the RF shower system 370, while communicating with the RF shower system 370 using the same method as the conventional reader-tag communication method. The RFID reader 310 transmits an interrogation signal to the RF shower system 370 using the RF signal f1 in the predetermined frequency band. Then, the RF shower system 370 loads tag information stored therein onto a response signal and transmits the response signal while receiving and reflecting the RF signal f1. Therefore, the RFID reader 310 can also easily obtain information about a passive tag 350 existing outside of the range of identification, that is, the interrogation zone In, through the RF shower system 370. In this way, the intelligent RFID system of the present invention is implemented so that the RFID reader 310 can be easily provided with tag information by the RF shower system 370 without personally moving to search for tags so as to read tag information from a plurality of tags.

As described above, in the intelligent RFID system 300 of the present invention, the activation of the passive tags 350 is not related to the RF signal f1 radiated by the RFID reader 310, so that there is no need to increase the power of the RF signal f1 transmitted from the RFID reader 310. Therefore, the RFID reader 310 for radiating low power frequency does not cause frequency interference with an adjacent RFID reader or an adjacent radio communication device. Further, since the high frequency wave f2 radiated by the RF shower system 370 uses a frequency f2 that does not cause frequency interference with an adjacent RFID reader or with an adjacent radio communication device, the power of the high frequency wave f2 can be freely increased without causing frequency interference. Accordingly, if the power of the RF shower system 370 is increased, all of the passive tags 350 existing in the radiation zone Ra (or interrogation zone) can be activated. Therefore, the passive tags existing in the radiation zone can perform multiple functions and high functions, such as an environmental sensing function. Further, the RF shower system 370 can read information from all of the passive tags 350 existing in the radiation zone Ra using the high frequency wave f2 for power transmission. Further, the read tag information is stored in the RF shower system 370. Meanwhile, the RFID reader reads information about tags from the RF shower system 370 using the same method as the reader-tag communication method, thus easily obtaining information about tags existing outside of the interrogation zone of the RFID reader, that is, the range of identification.

As described above, it is preferable that the frequency band of the high frequency wave f2, radiated by the RF shower system 370, and the frequency band of the RF signal f1, transmitted by the RFID reader 310, be set to be different from each other. However, in the RFID system 300 of the present invention, it is possible that the frequency band of the high frequency wave f2, radiated by the RF shower system 370, can be set to be identical to that of the RF signal f1 transmitted by the RFID reader 310. In this way, if the frequency bands of the high frequency wave f2 and the RF signal f1 are set to be identical to each other, it is preferable that the high frequency wave f1 be radiated only when the RFID reader 310 does not exist in the radiation zone Ra of the RF shower system 370, in order to prevent frequency interference between the RF shower system 370 and the RFID reader 310.

Further, the high frequency wave f2 radiated by the RF shower system 370 may be a pure Continuous Wave (CW) including no information, or a continuous wave including predetermined information. That is, the pure continuous wave, including no information, can be used at the time of merely supplying power without reading information from the passive tags 350. In contrast, the continuous wave including predetermined information can be used at the time of communicating with the plurality of passive tags 350 while transmitting power to the passive tags 350.

Further, when the RFID reader 310 transmits recording information to record information on the tags 350, the RF shower system 370 can transmit the recording information to the tags 350 using a simple relay method, or can transmit recording request information, output from the reader 310, to the tags 350 using both the communication with the reader 310 and the communication with the tags 350. Further, when the frequency bands of the high frequency wave f2 and the RF signal f1 are set to be identical to each other, an Ad-hoc network between tags can be realized. Further, when the reader is not included, an Ad-hoc network between tags can be realized if the frequencies of the high frequency wave f2 and the RF signal f1 are set to be different from each other. That is, all of the passive tags 350 existing in the radiation zone of the RF shower system 370 are not only activated, but can also form an interrogation zone and a response zone each having a predetermined size, using the high frequency wave f2 radiated at high power. Therefore, all of the tags 350, existing in the radiation zone of the RF shower system 370, can exchange information with other passive tags 350 existing in the interrogation zone and the response zone, each having a predetermined size, while exchanging an interrogation signal and a response signal with other passive tags 350.

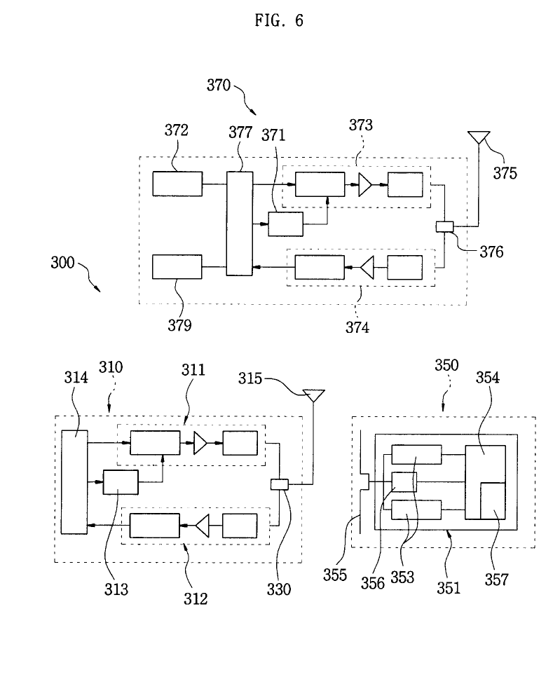

FIG. 6 is a diagram showing the construction of the reader 310, the tag 350 and the RF shower system 370 applied to the RFID system 300 of the present invention in detail. In the drawing, respective components are schematically shown, but those skilled in the art will easily understand the technical spirit of the present invention. The reason for this is that the technical spirit of the present invention relates to a system for collecting information from a plurality of passive tags and transmitting the collected tag information to the RFID tags using an RF shower system that radiates high frequency waves, and respective components, constituting such a system, can be relatively easily implemented based on well-known technology. Further, some of the components shown in the drawing can be deleted, added or modified if necessary. Therefore, the technical scope of the present invention is not limited to the above embodiments. Referring to FIG. 6, the RFID reader 310 is equal or similar to a conventional RFID reader. The RFID reader 310 includes an RF transmission unit 311 for modulating and transmitting an RF signal, an RF reception unit 312 for receiving and demodulating an RF signal, a frequency synthesizer 313 for generating a high frequency in a predetermined frequency band, an antenna 315 for transmitting or receiving an RF signal in a predetermined frequency band, and a microprocessor 314 for processing transmitted or received information. Further, reference numeral 330, not described, is a switch (or duplexer) for separately transmitting and receiving RF signals.

Further, the passive tag 350 is also equal or similar to a conventional passive tag. The passive tag 350 includes an antenna 355 and an IC chip 351, and does not include a battery therein. The IC chip 351 includes an RF circuit 353 for transmitting or receiving a high frequency signal, a control logic 354, and memory 357. Further, the antenna 355 is a dipole antenna capable of receiving a high frequency signal, and is a rectenna combined with a rectifier 356. The rectenna has a structure in which a rectifying diode is connected to a center portion of the dipole antenna. Therefore, the antenna 355 can receive Alternating Current (AC) electromagnetic waves radiated by the RF shower system 370 and convert the AC electromagnetic waves into Direct Current (DC) power. The antenna 355 of the passive tag 350 can receive both the high frequency wave f2 radiated by the RF shower system 370 and the RF signal f1 transmitted by the RFID reader 310.

Referring to FIG. 6 again, the RF shower system 370 has a structure similar to that of the RFID reader 310. That is, the RF shower system 370 includes a high frequency generation unit 371 for generating a high frequency wave f2 in a specific frequency band, an RF transmission unit 373 for modulating, amplifying and transmitting the high frequency wave f2, an RF reception unit 374 for receiving, amplifying and demodulating the high frequency wave f2 reflected by the passive tag 350, an antenna 375 for transmitting or receiving a high frequency wave in a predetermined frequency band, and a microprocessor 377 for processing transmitted or received information. The microprocessor 377 is connected to a power supply unit 372 and memory 379. Further, reference numeral 376, not described, is a switch (or duplexer) for separating transmitted and received high frequency waves. Meanwhile, since the RF shower system 370 is required to radiate high frequency waves at high power, the RF shower system 370 is superior to the RFID reader 310 in terms of size, performance and power.

Therefore, the high frequency wave f2, generated by the high frequency generation unit 371, is amplified to a high power wave by the amplifier of the RF transmission unit 373, and is then radiated outside the RF shower system. In this case, if the high frequency wave f2, generated by the high frequency generation unit 371, is radiated without being modulated, the high frequency wave f2 is a pure continuous wave for supplying power to the plurality of passive tags 350. Further, if a predetermined information signal is loaded onto the high frequency wave through the RF transmission unit 373, a signal wave is radiated, thus enabling communication while supplying power to the plurality of passive tags 350.

Next, the high frequency wave f2, radiated by the RF shower system 370, is reflected by the plurality of passive tags 350, and is then received through the antenna 375. Further, information included in the received high frequency wave f2 is demodulated by the demodulator of the RF reception unit 374, is processed by the microprocessor 377, and is then stored in the memory 379.

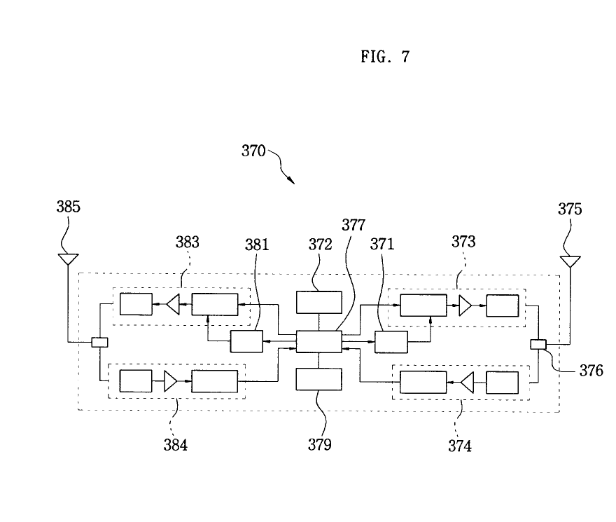

Further, the power supply unit 372 is required to drive the RF shower system 370, and is a private electric generator using typical power, an internal battery, an external power source, a solar cell, etc. Further, the RF shower system 370 loads tag information, stored in the memory 379, onto the RF signal f1 in a predetermined frequency band, and transmits the RF signal f1 with the tag information to the RFID reader 310 when a request is received from the RFID reader 310. In this case, the RF transmission unit 373 performs backscattered modulation on the RF signal f1 of the RFID reader 310, received through the antenna 375, and transmits the modulated signal, or the high frequency generation unit 371 generates a separate RF signal f1 and transmits the RF signal f1. In this way, the RF shower system 370 must simultaneously use the high frequency wave f2 and the RF signal f1 in predetermined frequency bands. Accordingly, as shown in FIG. 7, an antenna 385 and RF transmission/reception units 383 and 384 for transmitting or receiving the RF signal f1 can be separately provided. As described above, if the antenna f1 385, the RF transmission unit 383 and the RF reception unit 384 for the RF signal f1 are separately provided, the high frequency wave f2 can be radiated regardless of whether communication with the RFID reader 310 is performed, so that the passive tags 350 can be continuously activated. Further, the RF shower system 370 includes a signal processing means, such as an arbiter capable of arbitrating collisions between two or more RFID readers when interrogation signals are received from the two or more RFID readers 310.

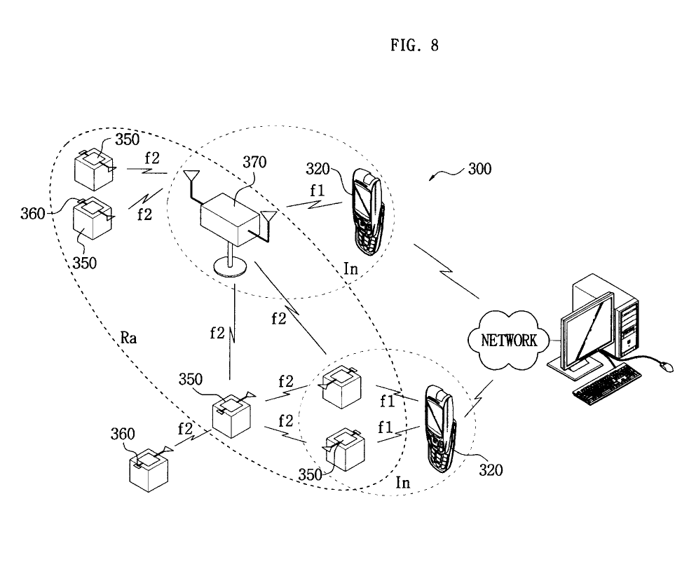

FIG. 8 is a diagram showing the construction of another embodiment of the intelligent RFID system 300 according to the present invention. The intelligent RFID system 300 includes RFID mobile communication terminals 320 each having an RFID reader 310, one or more passive tags 350, and an RF shower system 370 for transmitting power to the passive tags 350 in a wireless manner and communicating with the RFID mobile communication terminals 320 and the passive tags 350. Therefore, the passive tags 350 are supplied with power by a high frequency wave f2, which belongs to a predetermined frequency band and is radiated by the RF shower system 370, and are then activated. Further, each activated passive tag 350 communicates with the RFID mobile communication terminals 320 using an RF signal f1 in a predetermined frequency band. In this case, power is not transmitted between the RFID mobile communication terminals 320 and the tags 350, so that the power of the RF signal f1 is decreased as low as possible, thus minimizing frequency interference between adjacent RFID mobile communication terminals 320.

Meanwhile, the RF shower system 370 communicates with a plurality of passive tags 350 using the high frequency wave f2. That is, the RF shower system 370 can read information stored in the passive tags 350 while radiating the high frequency wave f2, including a predetermined interrogation signal, to the plurality of passive tags 350 and activating the passive tags 350. Each of the passive tags 350 performs backscattered modulation on the high frequency wave f2 radiated by the RF shower system 370, and then transmits a response signal. Further, information obtained from the plurality of passive tags 350 is stored in the memory of the RF shower system 370. The RF shower system 370 of the present invention periodically obtains and stores information about the tags 350 using the interrogation signal f2 as necessity requires even if there has been no information request from the RFID mobile communication terminal 320 with respect to all of the passive tags 350 existing in the radiation zone Ra thereof. Then, the RFID mobile communication terminal 320 communicates with the RF shower system 370 using the RF signal f1, and can obtain tag information stored in the RF shower system 370. That is, when the RFID mobile communication terminal 320 requests information about tags from the RF shower system 370 using an interrogation signal f1, the RF shower system 370 transmits information about all stored tags to the RFID mobile communication terminal 320, provided with the function of an RFID reader, using a response signal f1. In this case, the RF shower system 370 performs the same function that is performed in the case where a plurality of tags is operated, while entailing collisions between tags. Further, when the reader records information on the tags, the RF shower system 370 can perform a relay operation using a separate command, or can transmit recording information through communication. Further, in the RFID mobile communication terminal 320, an application program required to analyze and process the tag information is installed, so that desired information can be selected and viewed. Further, collected tag information can be transmitted to a remote place through a network.

### INDUSTRIAL APPLICABILITY

In the generation of a Ubiquitous Sensor Network (USN), it is forecasted that subminiature tags will be attached to vehicles, animals or persons, as well as to objects, such as the walls or floors of buildings and telegraph poles or paving blocks on streets, and readers capable of reading tag information will be installed in a plurality of places, or a user will carry a reader, collect information about the surrounding environment in real time and transmit the collected information through a network. Therefore, the tags used in USN have been required to have additional sensing and memory functions, in addition to the function of transmitting only identification information, as in the prior art, and to function as a ubiquitous sensor (u-sensor) for sensing information about the surrounding environment (temperature, humidity, pollution information, crevice information, etc.) by themselves and actively transmitting the environmental information to the network. Therefore, in advance of constructing such a Ubiquitous Sensor Network (USN), the development of a tag having a low cost, high functionality, and a very small size is required.

1. An intelligent Radio Frequency Identification (RFID) system for low-powered reader-tag communication, the RFID system including an RFID reader and one or more passive tags, comprising:
an RF shower system for radiating an electromagnetic wave in a predetermined frequency band to activate the passive tags, the RF shower system including predetermined communication means to read information from a plurality of passive tags existing in a radiation zone having a predetermined size and to provide stored tag information when a request is received from the RFID reader.

2. The intelligent RFID system according to claim 1, wherein the RF shower system is installed independent of the RFID reader, radiates a high frequency electromagnetic wave at high power to cover one or more passive tags, and forms a radiation zone having a predetermined size.

3. The intelligent RFID system according to claim 1, wherein the RF shower system stores information transmitted from the plurality of passive tags existing in the radiation zone while performing radio communication with the passive tags.

4. The intelligent RFID system according to claim 1, wherein the RF shower system reads information about a plurality of passive tags existing outside of a range of communication with the RFID while communicating with a plurality of passive tags existing in a wide range using a high frequency wave having higher power than that of an RF signal radiated by the RFID reader.

5. The intelligent RFID system according to claim 1, wherein the RF shower system transmits information collected from the passive tags existing in the radiation zone to the RFID reader when the RFID reader requests information about tags.

6. The intelligent RFID system according to claim 1, wherein the RF shower system controls RF signals transmitted by one or more RFID readers, thus preventing collisions between the RFID readers.

7. The intelligent RFID system according to claim 1, wherein the high frequency wave radiated by the RF shower system and the RF signal radiated by the RFID reader are in different frequency bands.

8. The intelligent RFID system according to claim 1, wherein the high frequency wave radiated by the RF shower system and the RF signal radiated by the RFID reader are in the same frequency band.

9. The intelligent RFID system according to claim 1, wherein the RF shower system includes memory for storing tag information transmitted by the passive tags.

10. An intelligent Radio Frequency Identification (RFID) system for low-powered reader-tag communication, comprising:
an RFID reader;
one or more tags; and
an RF shower system for radiating an electromagnetic wave in a predetermined frequency band to activate the passive tags, the RF shower system including predetermined communication means to read information from a plurality of passive tags existing in a radiation zone having a predetermined size and to provide stored tag information when a request is received from the RFID reader,
wherein the RF shower system reads information about a plurality of passive tags existing outside of a range of communication with the RFID while communicating with a plurality of passive tags existing in a wide range using a high frequency wave having higher power than that of an RF signal radiated by the RFID reader.

11. The intelligent RFID system according to claim 10, wherein the tags are active tags.

12. An intelligent Radio Frequency Identification (RFID) method for low-powered reader-tag communication, the RFID method being performed using an intelligent RFID system for low-powered reader-tag communication, the RFID system including an RFID reader, one or more passive tags, and an RF shower system radiating an electromagnetic wave in a high frequency band to activate the passive tags, and having communication means capable of communicating with both the RFID reader and the passive tags, the RFID method comprising:
an activation step of the RF shower system radiating a high frequency wave in a predetermined frequency band, transmitting power to one or more passive tags existing in a radiation zone thereof, and then activating the passive tags;
an RF shower system interrogation step of the RF shower system transmitting an interrogation signal to the plurality of activated passive tags existing in the radiation zone, using the high frequency wave in a predetermined frequency band; and
a passive tag response step of the plurality of passive tags, existing in the radiation zone of the RF shower system, performing backscattered modulation on the high frequency wave received from the RF shower system, thus transmitting a response signal.

13. The intelligent RFID method according to claim 12, further comprising:
a tag information storage step of the RF shower system storing tag information, read from the plurality of passive tags, in memory;
an RFID reader interrogation step of the RFID reader transmitting an interrogation signal to the RF shower system, using an RF signal in a predetermined frequency band; and
an RF shower system response step of the RF shower system providing tag information, stored in the memory, using the RF signal in a predetermined frequency band, in response to the interrogation signal from the RFID reader.

14. The intelligent RFID method according to claim 12, further comprising:
an RFID reader recording step of the RFID reader transmitting a predetermined recording signal to the RF shower system using the RF signal in a predetermined frequency band; and
an RF shower system recording step of the RF shower system receiving the recording signal from the reader, and transmitting recording information to the tags using a predetermined high frequency signal.

15. The intelligent RFID method according to claim 12, further comprising a step of forming an Ad-hoc network for exchanging an interrogation signal and a response signal among the plurality of tags, using a predetermined high frequency signal radiated by the RF shower system.
